(19) United States
(12) Patent Application Publication
(10) Pub. No.: US 2026/0168912 A1
(43) Pub. Date: Jun. 18, 2026

(54) APPARATUS AND METHOD FOR ACCELERATING GAS INFILTRATION INTO MATERIALS

(71) Applicant: METAL INDUSTRIES RESEARCH & DEVELOPMENT CENTRE, Kaohsiung (TW)

(72) Inventors: Zong-Rong LIU, Kaohsiung (TW); Hsiu-An TSAI, Kaohsiung (TW)

(21) Appl. No.: 18/984,947

(22) Filed: Dec. 17, 2024

(51) Int. Cl. G01N 17/00; G01M 3/04

(52) U.S. Cl. CPC G01N 17/00; G01M 3/04

(57) ABSTRACT

An apparatus and method for accelerating gas infiltration into materials comprises: a storage unit, configured to store at least one gas; a pressurization unit, connected to the storage unit, and configured to receive the gases and pressurize the gases; a reaction unit, connected to the storage unit and the pressurization unit, and configured to contain a to-be-tested material; a first valve, connected between the storage unit and the reaction unit; a heater, connected to the reaction unit, capable of setting a temperature and inputting heat energy to the reaction unit; and a second valve, connected among the storage unit, the pressurization unit, and the reaction unit.

### BACKGROUND

### Technical Field

The present invention relates to an apparatus for testing a hydrogen embrittlement degree, and in particular to, a testing apparatus and method capable of accelerating hydrogen embrittlement properties of a tested material.

### Related Art

Hydrogen is regarded as one of the new generation of clean energy sources. Gradually, there are companies developing hydrogen-related devices such as hydrogen fuel cells and hydrogen cars, and these hydrogen-related devices are expected to replace fossil fuel-based devices in future. However, the transportation and storage of hydrogen will have a negative impact on the contacted containers or conduits. For example, hydrogen embrittlement of metals means that when hydrogen diffuses into metals, the mechanical properties of metals, such as ductility and plasticity, are reduced, and the metals will suddenly break after a period of use. Due to delayed cracking, weakening of mechanical properties and embrittlement of metals, it is necessary to evaluate the sensitivity of metals to hydrogen and perform related tests.

At present, the material testing in a high-pressure hydrogen environment mainly includes: establishing a compressed hydrogen environment through high pressure such that the hydrogen acts and infiltrates into the surface of a test piece in the compressed hydrogen environment, taking out the to-be-tested material, and then performing tensile testing, circular patch cracking testing, etc. However, it takes too long for high-pressure hydrogen to infiltrate into the material, and the integrity of related testing devices is not high.

Based on the above, there is a need in the technical field for an apparatus capable of making high-pressure hydrogen rapidly infiltrate into the surface of the material while ensuring safety of the testing apparatus during the reaction.

### SUMMARY

In view of this, an objective of the present invention is to provide an apparatus and method for accelerating gas infiltration into materials. By means of the apparatus for accelerating gas infiltration into materials disclosed by the present invention, the changes in temperature and pressure in the environment where hydrogen infiltrates into the to-be-tested material can be effectively controlled, so that hydrogen infiltration into materials can be performed in a stable environment. By means of heating, the speed of reaction between hydrogen atoms and the to-be-tested material is increased, thereby improving the efficiency of hydrogen brittleness testing of the material.

According to the above objective, the present invention provides an apparatus for accelerating gas infiltration into materials, comprising: a storage unit, configured to store at least one gas; a pressurization unit, connected to the storage unit, and configured to receive the gases and pressurize the gases; a reaction unit, connected to the storage unit and the pressurization unit, and configured to contain a to-be-tested material; a first valve, connected between the storage unit and the reaction unit; a heater, connected to the reaction unit, and capable of setting a temperature and inputting heat energy to the reaction unit; and a second valve, connected among the storage unit, the pressurization unit, and the reaction unit.

In some examples, the storage unit inputs the gases to the pressurization unit, the pressurization unit pressurizes the gases to a pressure and transmits the gases to the reaction unit, the first valve and the second valve are configured to adjust a flow rate of the gases, and the gases infiltrate into the to-be-tested material at the temperature and the pressure in the reaction unit.

In some examples, the gases are hydrogen and an inert gas.

In some examples, the pressure is in a range of about 50 bar to 300 bar, and the temperature is in a range of about 100°C to 400°C.

In some examples, the reaction unit is connected to a temperature sensing unit and a pressure sensing unit.

In some examples, the pressurization unit, the heater, the temperature sensing unit and the pressure sensing unit are jointly connected with a control system.

In some examples, the apparatus for accelerating gas infiltration into materials further comprises: a first pressure regulator, connected between the storage unit and the first valve; a second pressure regulator, connected among the storage unit, the pressurization unit, and the second valve; and a third pressure regulator, independently connected among the second pressure regulator, the pressurization unit, and the storage unit, and configured to assist in control of the pressure of the gases in the second pressure regulator.

In some examples, the storage unit and the reaction unit are jointly connected to an exhaust system, a fourth pressure regulator is connected between the storage unit and the reaction unit and configured to discharge the gases out of the reaction unit and regulate the pressure of the gases, and the exhaust system is connected to a third valve and a fifth pressure regulator to form a loop.

The present invention provides a method for accelerating gas infiltration into materials, comprising the following steps: placement of to-be-tested material: placing a to-be-tested material in a reaction unit; introduction of inert gas and confirmation for leakage: continuously inputting an inert gas into the reaction unit while controlling a flow rate of the inert gas by a first pressure regulator until the reaction unit is filled with the inert gas, repeatedly introducing and discharging the inert gas to remove the original gas in the reaction unit, and detecting whether there is gas leakage in the reaction unit; if there is leakage, confirming a position of the inert gas leakage in the reaction unit, and relocking the reaction unit; discharge of inert gas and introduction of hydrogen: if there is no inert gas leakage, discharging the inert gas out of the reaction unit by an exhaust system, and introducing the hydrogen into the reaction unit; heating and pressurization: setting a temperature and inputting heat energy by a heater, and pressurizing the hydrogen and inputting the hydrogen to the reaction unit by a pressurization unit; infiltration of to-be-tested material: enabling the hydrogen to infiltrate into the to-be-tested material at a controlled temperature and a controlled pressure; discharge of gas mixture: discharging the hydrogen out of the reaction unit, inputting the inert gas by the storage unit, mixing the hydrogen and the inert gas to form a gas mixture, and discharging the gas mixture out of the exhaust system by the exhaust system; and removal of to-be-tested material: removing the to-be-tested material from the reaction unit after the temperature and the pressure drop to normal values.

In some examples, the pressure is in a range of about 50 bar to 300 bar, and the temperature is in a range of about 100°C to 400°C.

In some examples, the method for accelerating gas infiltration into materials further comprises the following steps: analysis of to-be-tested material: performing a tensile test and a thermal desorption test on the to-be-tested material, and analyzing mechanical properties and a hydrogen content of the to-be-tested material; and data acquisition: acquiring at least one result data of the to-be-tested material.

Compared with the related art, the present invention has the following technical characteristics:

According to the apparatus and method for testing materials at a controlled temperature and a controlled pressure in the present invention, the hydrogen in the reaction unit is pressurized and heated by the pressurization unit and the heater, so that the hydrogen reacts with the to-be-tested material and the speed of hydrogen infiltration into the to-be-tested material is increased. The pressure and the temperature of the reaction unit are detected by the pressure sensing unit and the temperature sensing unit and inputted to the control system, the control system controls the pressure and the temperature of the pressurization unit and the heater such that the temperature and the pressure in the reaction unit reach a dynamic equilibrium. After the to-be-tested material reaches an osmotic equilibrium of hydrogen, the hydrogen is discharged out of the reaction unit, the storage unit inputs the inert gas, and the exhaust system is started to discharge the gas mixture formed by the inert gas and the hydrogen. By means of the heat energy provided by the heater, the speed of hydrogen infiltration into the material is effectively increased. The pressure sensing unit and the temperature sensing unit monitor the pressure and the temperature in the reaction unit in real time, so that the reaction unit reaches the dynamic equilibrium in the hydrogen environment while ensuring the safety of the process of hydrogen infiltration into the to-be-tested material.

### BRIEF DESCRIPTION OF THE DRAWINGS

FIG. 1 is a structural diagram of an apparatus for accelerating gas infiltration into materials according to the present invention;

FIG. 2 is a flowchart showing steps of a method for accelerating gas infiltration into materials according to the present invention; and

FIG. 3 is a flowchart showing steps of a method for accelerating gas infiltration into materials according to another example of the present invention.

### DETAILED DESCRIPTION

The embodiments of the present invention are described below by means of specific examples for further detailed description of the present invention, and may also be implemented and applied by means of other different specific examples. The accompanying drawings of the present invention are mainly simplified schematic diagrams to illustrate the basic structure of the present invention in a schematic way, and various modifications and changes can be made to various details in this specification based on different viewpoints and applications without departing from the spirit of the present invention.

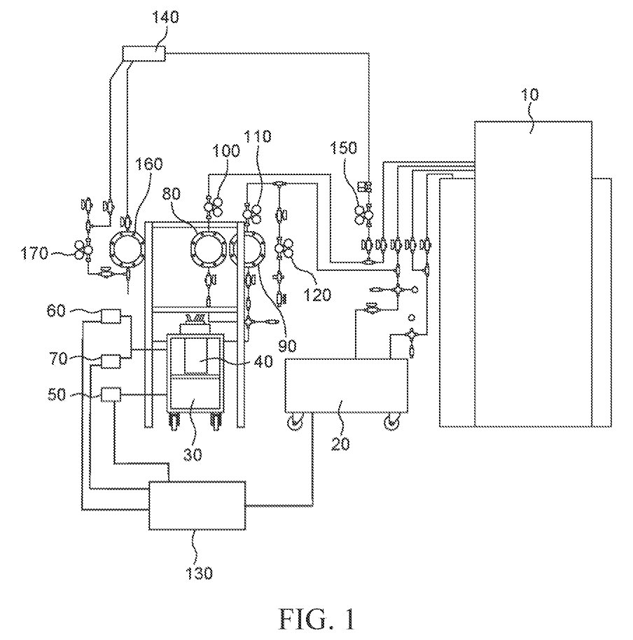

Referring to FIG. 1, FIG. 1 is a structural diagram of an apparatus for accelerating gas infiltration into materials according to the present invention.

A storage unit 10 is connected to a pressurization unit 20. The storage unit 10 is configured to store hydrogen and an inert gas. The pressurization unit 20 pressurizes the storage unit 10 such that the hydrogen can be stored in the storage unit 10. Because the density of hydrogen is extremely low, in order to avoid the risk of leakage of hydrogen from the storage unit, the hydrogen is stored at high pressure. A reaction unit 30 is connected to the storage unit 10 and the pressurization unit 20, and a to-be-tested material 40 is contained in the reaction unit 30. The to-be-tested material 40 may be a metal, an alloy or a metal-containing composite, and is not limited to any metal-containing material. A heater 50 is connected to the reaction unit 30, and configured to set a temperature and input heat energy to the reaction unit 30. The reaction unit 30 is connected with a pressure sensing unit 60 and a temperature sensing unit 70, and configured to monitor a temperature and a pressure in the reaction unit 30.

A first valve 80 is connected between the storage unit 10 and the reaction unit 30. A second valve 90 is connected among the storage unit 10, the pressurization unit 20, and the reaction unit 30. The first valve 60 and the second valve 70 are mainly configured to control the flow of the hydrogen and the hydrogen.

A first pressure regulator 100 is connected between the storage unit 10 and the first valve 80. A second pressure regulator 110 is connected among the storage unit 10, the pressurization unit 20, and the second valve 90. A third pressure regulator 120 is independently connected among the storage unit 10, the pressurization unit 20, and the second pressure regulator 110. The first pressure regulator 100, the second pressure regulator 110, and the third pressure regulator 120 are mainly configured to regulate the pressure of the hydrogen and the inert gas. The third pressure regulator 120 is configured to assist in control of the pressure of the gases in the second pressure regulator 110. Since the second pressure regulator 110 is connected with the pressurization unit 20, the pressure of the gases is controlled within the set range.

The storage unit 10 stores the hydrogen under high pressure through the pressurization unit 20, the inert gas is stored in the storage unit 10, and the hydrogen and the inert gas are inputted to the reaction unit 30. After the pressurization unit 20 pressurizes the hydrogen, the hydrogen reacts with the to-be-tested material 40 in the reaction unit 30, and the heater 50 sets a temperature and outputs heat energy to the reaction unit 30, so as to increase the speed of hydrogen infiltration into the to-be-tested material 40. Moreover, the first pressure regulator 100, the second pressure regulator 110, and the third pressure regulator 120 control the pressure of the hydrogen, so that the hydrogen infiltrates into the to-be-tested material 40.

In the apparatus for accelerating gas infiltration into materials, the pressure is in a range of about 50 bar to 300 bar, and the temperature is in a range of about 100°C to 400°C. When the hydrogen infiltrates into the to-be-tested material 40 in the reaction unit 30, the pressure sensing unit 60 and the temperature sensing unit 70 synchronously monitor the pressure and the temperature of the reaction unit 30. The pressurization unit 20, the heater 50, the pressure sensing unit 60, and the temperature sensing unit 70 are jointly connected with a control system 130 to form a loop. After the pressure sensing unit 60 and the temperature sensing unit 70 detect a temperature value and a pressure value of the reaction unit 30, the temperature value and the pressure value are inputted to the control system 130. The control system 130 automatically controls whether pressurization or depressurization of the pressurization unit 20 and heating or cooling of the heater 50 are needed according to the received temperature value and pressure value, so that the to-be-tested material 40 and the hydrogen in the reaction unit 30 reach a dynamic equilibrium.

The storage unit 10 and the reaction unit 30 are jointly connected with an exhaust system 140, and a fourth pressure regulator 150 is connected between the storage unit and the reaction unit. The fourth pressure regulator 150 is configured to control the pressure of the gases discharged from the reaction unit 30 to the exhaust system 140, and the exhaust system 140 is connected to a third valve 160 and a fifth pressure regulator 170 to form a loop. The fifth pressure regulator 170 controls the pressure of the hydrogen and the inert gas discharged out of the discharge system 140. The discharge concentration of the hydrogen in the gas mixture needs to be lower than a lower explosion limit so as to ensure the safety of the apparatus. The third valve 160 is configured to control whether to discharge the gases out of the discharge system 140. If so, the discharge system 140 is started, so that the gases are discharged. If not, the discharge system 140 is not started.

In this example, the gases flow among the units in the apparatus for accelerating gas infiltration into materials. High-pressure conduits are used as gas flow channels in the apparatus, so as to ensure the safety and stability of gas delivery to the working units.

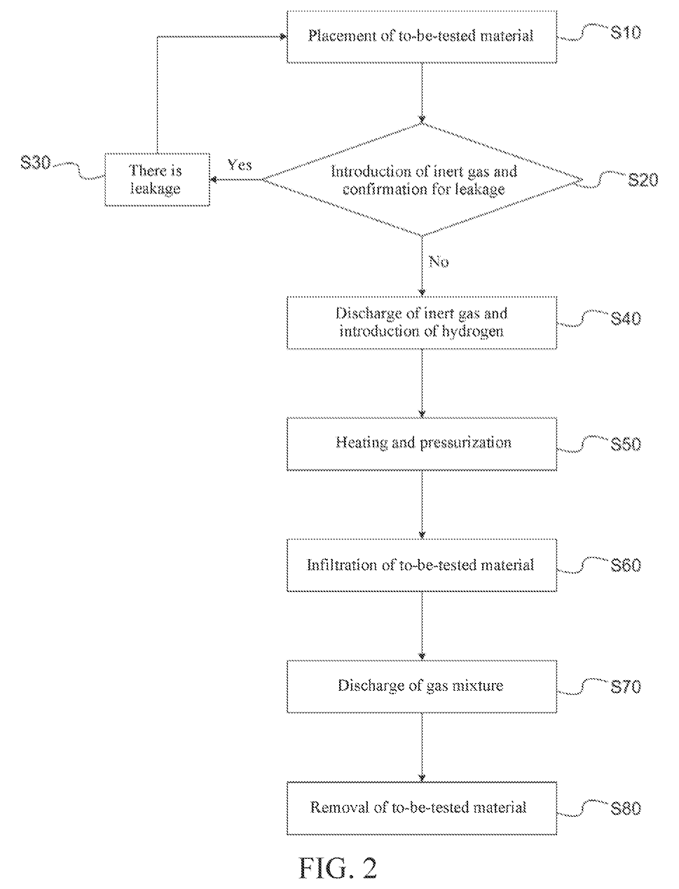

FIG. 2 is a flowchart showing steps of a method for accelerating gas infiltration into materials according to the present invention.

S10: Placement of to-be-tested material: A to-be-tested material 40 is placed in a reaction unit 30, and the reaction unit 30 is locked. In other words, the reaction unit 30 is opened, and the to-be-tested material 40 is placed therein. The to-be-tested material may be a metal, an alloy or a metal-containing composite, and is not limited to any metal-containing material.

S20: Introduction of inert gas and confirmation for leakage: An inert gas is continuously inputted into the reaction unit 30 while controlling a flow rate of the inert gas by a first pressure regulator 100 until the reaction unit is filled with the inert gas. The inert gas is repeatedly introduced and discharged to remove the original gas in the reaction unit, and whether there is gas leakage in the reaction unit 30 is detected. Specifically, by repeatedly introducing the inert gas into the reaction unit 30 and discharging the inert gas out of the reaction unit, the original gas in the reaction unit 30 is discharged out of the reaction unit 30 together with the inert gas, and in the process of continuously introducing the inert gas, whether the pressure value shown by the pressure sensing unit 60 has changed is confirmed, so that the next step may be performed.

S30: If there is leakage, a position of the inert gas leakage in the reaction unit 30 is confirmed, and the reaction unit 30 is relocked. In the process of continuously introducing the inert gas to the reaction unit, the pressure value shown by the pressure sensing unit 60 continuously decreases, indicating that there is gas leakage in the reaction unit 30, so the reaction unit 30 is relocked to ensure no leakage of the inert gas.

S40: Discharge of inert gas and introduction of hydrogen: If there is no inert gas leakage, the inert gas is discharged out of the reaction unit 30 by an exhaust system 140, and the hydrogen is introduced into the reaction unit 30. The pressure value shown by the pressure sensing unit 60 is continuously constant, indicating that there is no leakage in the reaction unit 30. After the inert gas is discharged out of the reaction unit 30, the hydrogen is inputted into the reaction unit 30, so that the reaction unit is filled with the hydrogen.

S50: Heating and pressurization: A heater 50 sets a temperature and inputs heat energy, and a pressurization unit 20 pressurizes the hydrogen and inputs the hydrogen to the reaction unit 30. The heater 50 sets the temperature in a range of 100°C to 400°C, and the pressurization unit 20 outputs the pressure in a range of 50 bar to 300 bar.

S60: Infiltration of to-be-tested material: The hydrogen is enabled to infiltrate into the to-be-tested material 40 at a controlled temperature and a controlled pressure. The pressurization unit 20 and the heater 50 pressurize and heat the hydrogen in the reaction unit 30, so that the hydrogen in the reaction unit 30 infiltrates into the to-be-tested material 40 until the to-be-tested material 40 reaches an osmotic equilibrium of hydrogen. The purpose of the heating is to increase the speed of hydrogen infiltration into the to-be-tested material 40. Upon receiving the temperature value and the pressure value of the reaction unit 30 detected by the pressure sensing unit 60 and the temperature sensing unit 70, the control system 130 automatically controls whether heating or cooling and pressurization or depressurization are needed so as to reach a dynamic equilibrium of the temperature and the pressure in the reaction unit.

S70: Discharge of gas mixture: The hydrogen is discharged out of the reaction unit 30, the storage unit 10 inputs the inert gas, the hydrogen and the inert gas are mixed to form a gas mixture, and the exhaust system 140 discharges the gas mixture out of the exhaust system 140. After the to-be-tested material 40 reaches a concentration equilibrium of hydrogen, the hydrogen is discharged out of the reaction unit 30, and the storage unit inputs the inert gas such that the hydrogen and the inert gas form the gas mixture in the conduit. Then, the exhaust system 140 discharges the gas mixture out of the exhaust system 140. Through the control of the third valve 160, the gas mixture is discharged out of the exhaust system 140, and the fifth pressure regulator 170 controls the pressure of the discharged gas mixture. The hydrogen concentration of the discharged gas mixture needs to be lower than a lower explosion limit so as to ensure the safety of the testing process.

S80: Removal of to-be-tested material: The to-be-tested material 40 is removed from the reaction unit 30 after the temperature and the pressure drop to normal values. After the hydrogen is completely discharged out of the reaction unit 30, the pressure sensing unit 60 shows no pressure value, indicating that there is no gas in the reaction unit 30. The temperature sensing unit 70 shows that the temperature has dropped to room temperature, indicating that the reaction unit 30 is not generating heat. The exhaust system 140 discharges the gas mixture formed by the hydrogen and the inert gas out of the exhaust system 140, so that the to-be-tested material 40 may be removed from the reaction unit 30.

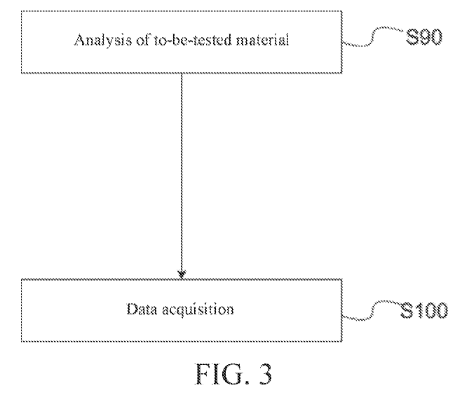

Referring to FIG. 3, FIG. 3 is a flowchart showing steps of a method for accelerating gas infiltration into materials according to another example of the present invention.

In this example, the method for accelerating gas infiltration into materials further includes steps as follows. S90: Analysis of to-be-tested material: A tensile test and a thermal desorption test are performed on the to-be-tested material 40, and mechanical properties and a hydrogen content of the to-be-tested material 40 are analyzed. The tensile test is preferably a low-strain-rate tensile test, and its purpose is to measure the mechanical properties of the to-be-tested material. The purpose of the thermal desorption test is to detect the hydrogen content in the to-be-tested material.

S100: Data acquisition: Result data of the to-be-tested material 40 is acquired. The test result data of the to-be-tested material 40 is analyzed. The result data of the to-be-tested material 40 in the tensile test includes mechanical properties such as yield strength, absolute tensile strength, elongation, and reduction of area. The correlation between the hydrogen embrittlement state and the hydrogen infiltration content is tested in the thermal desorption test. Temperature-pressure-hydrogen content and temperature-pressure-mechanical properties relation diagrams can be obtained based on the result data.

According to the apparatus and method for testing materials at a controlled temperature and a controlled pressure in the present invention, the hydrogen in the reaction unit 30 is pressurized and heated by the pressurization unit 20 and the heater 50, so that the hydrogen reacts with the to-be-tested material 40 and the speed of hydrogen infiltration into the to-be-tested material 40 is increased. The pressure and the temperature of the reaction unit 30 are detected by the pressure sensing unit 60 and the temperature sensing unit 70 and inputted to the control system 130, the control system controls the pressure and the temperature of the pressurization unit 20 and the heater 50 such that the temperature and the pressure in the reaction unit 30 reach a dynamic equilibrium. After the to-be-tested material reaches an osmotic equilibrium of hydrogen, the hydrogen is discharged out of the reaction unit, the storage unit inputs the inert gas, and the exhaust system 140 is started to discharge the gas mixture formed by the inert gas and the hydrogen. By means of the heat energy provided by the heater 50, the speed of hydrogen infiltration into the material is effectively increased. The pressure sensing unit 60 and the temperature sensing unit 70 monitor the pressure and the temperature in the reaction unit 30 in real time, so that the reaction unit 30 reaches the dynamic equilibrium in the hydrogen environment while ensuring the safety of the process of hydrogen infiltration into the to-be-tested material 40.

What is claimed is:

1. An apparatus for accelerating gas infiltration into materials, comprising:
a storage unit, configured to store at least one gas;
a pressurization unit, connected to the storage unit, and configured to receive the gases and pressurize the gases;
a reaction unit, connected to the storage unit and the pressurization unit, and configured to contain a to-be-tested material;
a first valve, connected between the storage unit and the reaction unit;
a heater, connected to the reaction unit, and capable of setting a temperature and inputting heat energy to the reaction unit; and
a second valve, connected among the storage unit, the pressurization unit, and the reaction unit,
wherein the storage unit inputs the gases to the pressurization unit, the pressurization unit pressurizes the gases to a pressure and transmits the gases to the reaction unit, the first valve and the second valve are configured to adjust a flow rate of the gases, and the gases infiltrate into the to-be-tested material at the temperature and the pressure in the reaction unit.

2. The apparatus for accelerating gas infiltration into materials according to claim 1, wherein the gases are hydrogen and an inert gas.

3. The apparatus for accelerating gas infiltration into materials according to claim 1, wherein the pressure is in a range of about 50 bar to 300 bar, and the temperature is in a range of about 100°C to 400°C.

4. The apparatus for accelerating gas infiltration into materials according to claim 1, wherein the reaction unit is connected to a temperature sensing unit and a pressure sensing unit.

5. The apparatus for accelerating gas infiltration into materials according to claim 4, wherein the pressurization unit, the heater, the pressure sensing unit, and the temperature sensing unit are jointly connected with a control system.

6. The apparatus for accelerating gas infiltration into materials according to claim 1, further comprising:
a first pressure regulator, connected between the storage unit and the first valve;
a second pressure regulator, connected among the storage unit, the pressurization unit, and the second valve; and
a third pressure regulator, independently connected among the second pressure regulator, the pressurization unit, and the storage unit, and configured to assist in control of the pressure of the gases in the second pressure regulator.

7. The apparatus for accelerating gas infiltration into materials according to claim 2, wherein the storage unit and the reaction unit are jointly connected to an exhaust system; the apparatus for accelerating gas infiltration into materials further comprises a fourth pressure regulator; after the hydrogen is discharged by the reaction unit, the hydrogen and the inert gas are mixed to form a gas mixture, and the fourth pressure regulator discharges the gas mixture and regulates the pressure of the gases; and the exhaust system is connected to a third valve and a fifth pressure regulator to form a loop.

8. A method for accelerating gas infiltration into materials, comprising the following steps:
placement of to-be-tested material: placing a to-be-tested material in a reaction unit, and locking the reaction unit;
introduction of inert gas and confirmation for leakage: continuously inputting an inert gas into the reaction unit while controlling a flow rate of the inert gas by a first pressure regulator until the reaction unit is filled with the inert gas, repeatedly introducing and discharging the inert gas to remove the original gas in the reaction unit, and detecting whether there is gas leakage in the reaction unit;
if there is leakage, confirming a position of the inert gas leakage in the reaction unit, and relocking the reaction unit;
discharge of inert gas and introduction of hydrogen: if there is no inert gas leakage, discharging the inert gas out of the reaction unit by an exhaust system, and introducing the hydrogen into the reaction unit;
heating and pressurization: setting a temperature and inputting heat energy by a heater, and pressurizing the hydrogen and inputting the hydrogen to the reaction unit by a pressurization unit;
infiltration of to-be-tested material: enabling the hydrogen to infiltrate into the to-be-tested material at a controlled temperature and a controlled pressure;
discharge of gas mixture: discharging the hydrogen out of the reaction unit, inputting the inert gas by the storage unit, mixing the hydrogen and the inert gas to form a gas mixture, and discharging the gas mixture out of the exhaust system by the exhaust system; and
removal of to-be-tested material: removing the to-be-tested material from the reaction unit after the temperature and the pressure drop to normal values.

9. The method for accelerating gas infiltration into materials according to claim 8, wherein the pressure is in a range of about 50 bar to 300 bar, and the temperature is in a range of about 100°C to 400°C.

10. The method for accelerating gas infiltration into materials according to claim 8, further comprising the following steps:
analysis of to-be-tested material: performing a tensile test and a thermal desorption test on the to-be-tested material, and analyzing mechanical properties and a hydrogen content of the to-be-tested material; and
data acquisition: acquiring at least one result data of the to-be-tested material.
